(19) United States
(12) Patent Application Publication
(10) Pub. No.: US 2022/0241626 A1
(43) Pub. Date: Aug. 4, 2022

(54) Temporary Horizontal Lifeline Device

(71) Applicant: BEXUS INDUSTRIES CO., LTD., Taichung City (TW)

(72) Inventors: Kai Chieh Yang, Taichung City (TW); Yi-Ching Lin, Taichung City (TW)

(21) Appl. No.: 17/210,427

(22) Filed: Mar. 23, 2021

(30) Foreign Application Priority Data
Feb. 1, 2021 (TW) 110103626

(51) Int. Cl. A62B 35/00; B65H 75/48; B65H 75/44

(52) U.S. Cl. CPC A62B 35/0056; B65H 75/4442; B65H 75/486

(57) ABSTRACT

A temporary horizontal lifeline device includes a main frame, a central shaft pivotally arranged on the main frame, a drum and an external gear affixed on the central shaft, a spanner adapted for driving the central shaft to rotate, and a cable member winded around the drum. A gear groove is arranged on the periphery of the external gear. A first spring is arranged on the main frame so as to provide a force to enable the drum to retrieve the cable member. The main frame also comprises a brake element and a detent provided thereon. The brake element has a first state for restrict the gear groove and a second state for releasing the gear groove, which prevents the external gear from rotating forward and backward when the external gear is in the first state. The detent has a first position to mesh the gear groove and a second position to release the gear groove, so that the external gear is only allowed to unidirectionally rotate in the first position. Accordingly, the present invention is convenient and safe to use when conducting retrieving operation, and effectively improves the stress concentration issue of conventional detents.

### BACKGROUND OF THE PRESENT INVENTION

### Field of Invention

The present invention provides a temporary horizontal lifeline device, and more particularly to the technical field of enhancing the convenience and security of the line retrieving operation and improving the stress concentration issue of the conventional detent of lifeline device.

### Description of Related Arts

According to the prior art, as shown in U.S. Pat. No. 8,739,929, it is utilized for aloft construction site (e.g., steel structure construction building) where personal safety belt or other safety device hanging connection is unavailable, so that the worker can horizontally move and work in a secure manner. According to the prior art, the site has a first anchoring structure and a second anchoring structure of the same height vertically provided, so as to allow a horizontal cabling operation to be conducted between the first anchoring structure and the second anchoring structure for this prior technology, and therefore enable personal safety belt or other safety device hanging connection to be connected with the cable, such that the user is able to move horizontally along the horizontal cable and perform the tasks thereof.

However, it has the following drawbacks:

First, it makes use of a small gear to mesh with the main gear plate and the detent prepresses the small gear by means of a torsion spring, so as to allow one-hand operation during the horizontal cabling, but when the user finishes his/her tasks and start to perform the retrieving operation, the user has to grip this conventional device with one hand, while rotate the crank to retrieve the cable with the other hand. Otherwise, the damping effect produced by the detent and the small gear to the main gear plate may not be overcome. However, the two-hand retrieving operation manner not only requires great effort, but also increases the risks of the barycenter offset of the worker or even falling accident even when the user's hands and feet slightly fail to coordinate well.

Second, when the user finishes horizontal cabling and requires cabling tension or when the user falls, it only relies on the edge of the detent to obliquely lock the small gear. As a result, the edge of the detent meshing with the small gear is highly likely to have a stress concentration issue, rendering the detent in a risk of cracking and failing, which can lead to failure of the entire cabling and cause enormous danger.

### SUMMARY OF THE PRESENT INVENTION

The present invention provides a temporary horizontal lifeline device, which includes:

a main frame, a central shaft pivotally arranged on the main frame, an external gear and a drum affixed on the central shaft, a spanner adapted for driving the central shaft to rotate, and a cable member winded around the drum, wherein the external gear has a plurality of gear grooves arranged on the periphery thereof, wherein the main frame further comprises a first spring provided thereon to provide a constant force for the drum to retrieving the cable member, wherein the characteristics is:

the main frame also comprises a brake element and a detent, wherein the brake element has a first state to restrict the gear grooves and a second state to release and free the gear grooves, such that the external gear is not allowed to rotate forward and backward under the first state, wherein the detent has a first position meshing with the gear grooves and a second position releasing the gear grooves, so that the external gear is only allowed to rotate unidirectionally under the first position.

Accordingly, during the retrieving operation, the device provided by the present invention only needs to have the brake element under the second state and the detent at the second position to eliminate the damping action of the prior art. Then, the first spring may smoothly drive the drum to retrieve the cable member, which is not only labor saving, but also easy for cable retrieving with one hand, providing relatively easy overall operation and enhancing the security of the personnel moving and cable retrieving effectively.

Furthermore, after the cabling operation, the device provided by the present invention has the brake element being switched to the first state and the detent being switched to the first position, so that the cable responding to cable tension or personnel falling mainly with the brake element to lock the external gear instead of with the detent. Accordingly, the present invention is capable of enhancing the stress concentration issues of the prior art.

### BRIEF DESCRIPTION OF THE DRAWINGS

FIG. 1 is a perspective view of a temporary horizontal lifeline device according to a preferred embodiment of the present invention.

FIG. 2 is an exploded view illustrating the primary elements (without the housing) of the temporary horizontal lifeline device according to the above preferred embodiment of the present invention.

FIG. 3 is a partially exploded front perspective view of the temporary horizontal lifeline device with the housing disassembled according to the above preferred embodiment of the present invention.

FIG. 4 is a perspective view illustrating the positions of the drum, the external gear, the brake element, and the detent according to the above preferred embodiment of the present invention.

FIG. 5 is a rear perspective view of FIG. 3.

FIG. 6 is a sectional view of FIG. 1 along the A-A line.

FIG. 7 is a schematic view illustrating the temporary horizontal lifeline device not in use or after the horizontal cabling operation is finished that brake element is in a first state and the detent is at a first position according to the above preferred embodiment of the present invention.

FIG. 8 is a schematic view illustrating the device of the present invention is in use of the horizontal cabling operation that the brake element is in a second state and the detent is kept at a first position according to the above preferred embodiment of the present invention.

FIG. 9 is a schematic view illustrating a preliminary completion of a horizontal cabling operation for the device according to the above preferred embodiment of the present invention.

FIG. 10 is a schematic view illustrating the device of the present invention responds to the adjustment of the horizontal tension of the cable member that the brake element is controlled to be in a second state and the detent is switched to a second position according to the above preferred embodiment of the present invention.

FIG. 11 is a sectional view illustrating the connection assembly without horizontal tension adjustment of the cable member according to the above preferred embodiment of the present invention.

FIG. 12 is a sectional view illustrating the connection assembly with horizontal tension of the cable member after adjusted according to the above preferred embodiment of the present invention.

### DETAILED DESCRIPTION OF THE PREFERRED EMBODIMENT

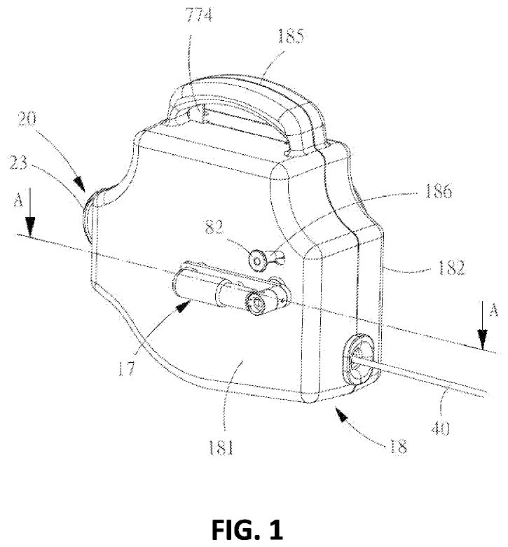

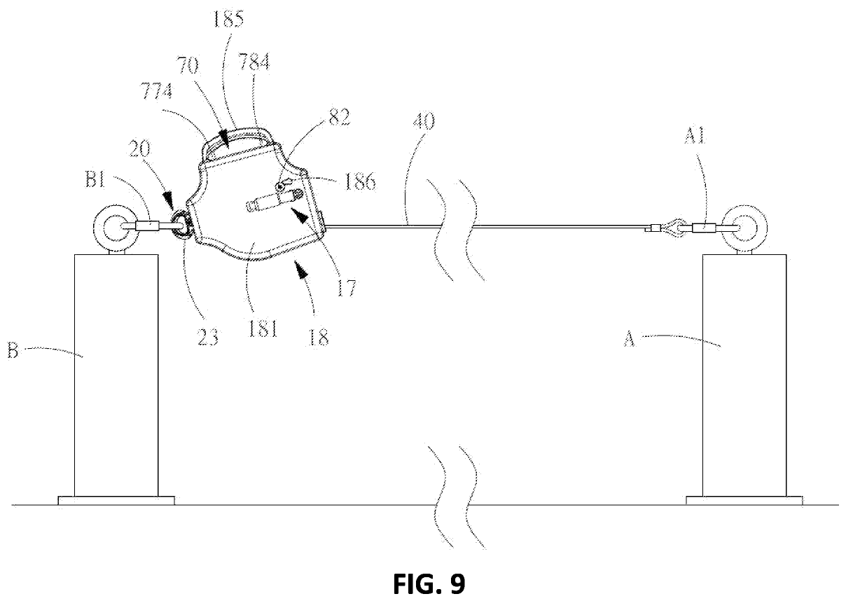

Referring to FIGS. 1 and 9, the present invention provides a temporary horizontal lifeline device adapted for operably performing a horizontal cabling operation or a retrieving operation between a first anchoring structure A and a second anchoring structure B, wherein the device includes a main frame 10, a connection assembly 20, a drum 30, a cable member 40, a first spring 50, an external gear 60, a brake element 70, and a detent 80.

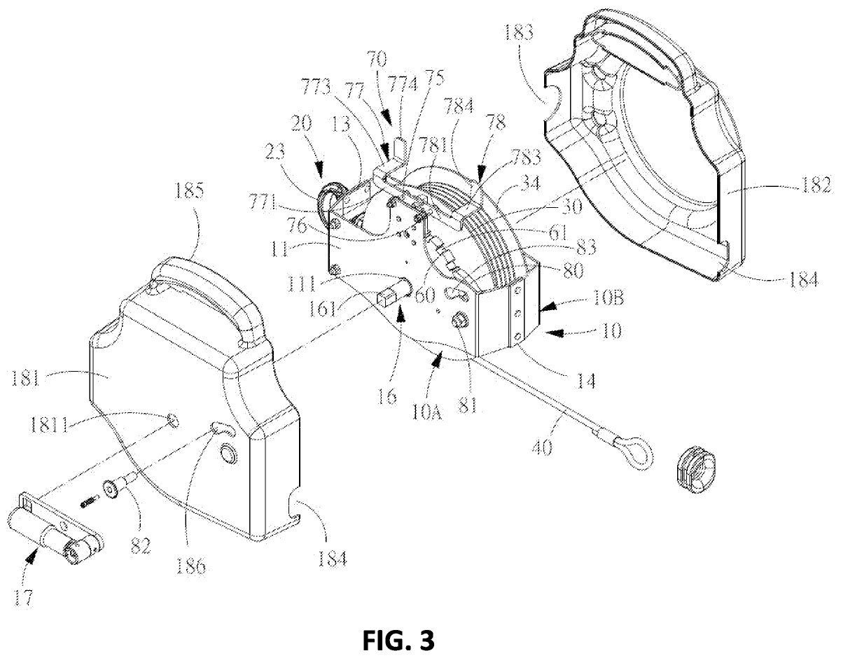

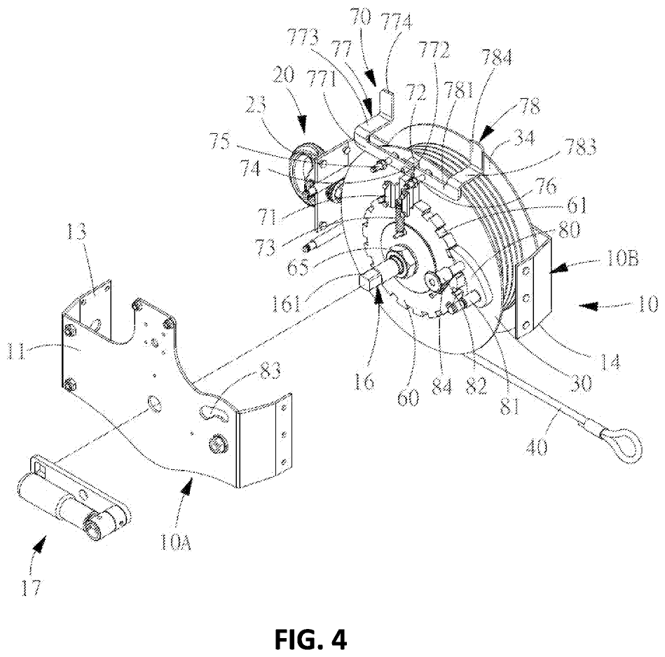

The main frame 10, referring to FIGS. 1-6, comprises a front bracket 10A and a rear bracket 10B, both having reverse-U-shape cross section. The left and right sides of the front bracket 10A and the rear bracket 10B are rivetedly connected, so as to define a front plate 11 and a rear plate 12 opposite to each other and a left plate 13 and a right plate 14 opposite to each other for the main frame 10, and further define and provide a chamber 15 with the front plate 11, the rear plate 12, the left plate 13, and the right plate 14 thereamong with the upper and lower sides opened. The front plate 11 has a front hole 111 arranged thereon to communicate the inside and outside of the chamber 15, while the rear plate 12 has a rear hole 121 arranged thereon coordinating and corresponding to the front hole 111. A rotatable central shaft 16 is provided and pivotally arranged in the front hole 111 and the rear hole 121, wherein the central shaft 16 is arranged across the chamber 15 and controlled to protrude the front end thereof from the front of the front plate 11 and has a lever portion 161 adapted for mounting a spanner 17 that is openable and collapsible, such that when the spanner 17 in the opened state is capable of being utilized to drive the central shaft 16 to rotate for adjusting the tension of the cable member 40 during a horizontal cabling operation. The central shaft 16 also has a radially expanded yoke 162 and a screw segment 163 arranged thereon within the area of the chamber 15, and a first key slot 164 arranged thereon between the yoke 162 and the screw segment 163. The first key slot 164 is adapted for a key block 165 to be mounted therein, wherein the rear end of the central shaft 16 is protruded from the back side of the rear plate 12. The central shaft also has an inlay groove 166 radially and sunkenly provided on the periphery of the rear end thereof. For the overall outward appearance, the main frame 10 also comprises a housing 18 covered thereon, wherein the housing 18 comprises a front shell 181 and a rear shell 182 coupled with each other for the construction thereof, wherein the front shell 181 has an aperture arranged thereon for the lever portion 161 of the central shaft 16 to pass through. The housing 18 further has a first hole 183 arranged on the left side thereof and a second hole 184 arranged on the right side thereof, wherein the first hole 183 is for a connection assembly 20 to fit in, while the second hole 184 is for the cable member 40 to pass in and out.

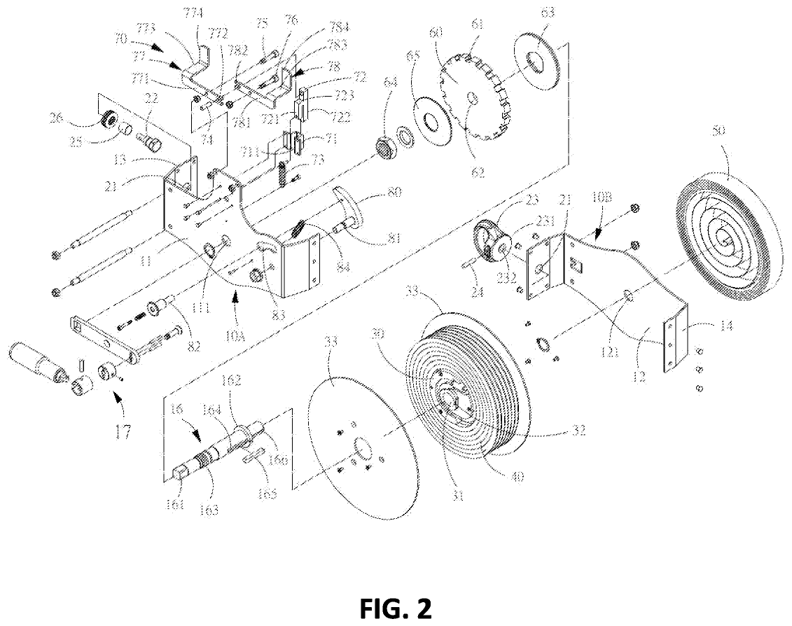

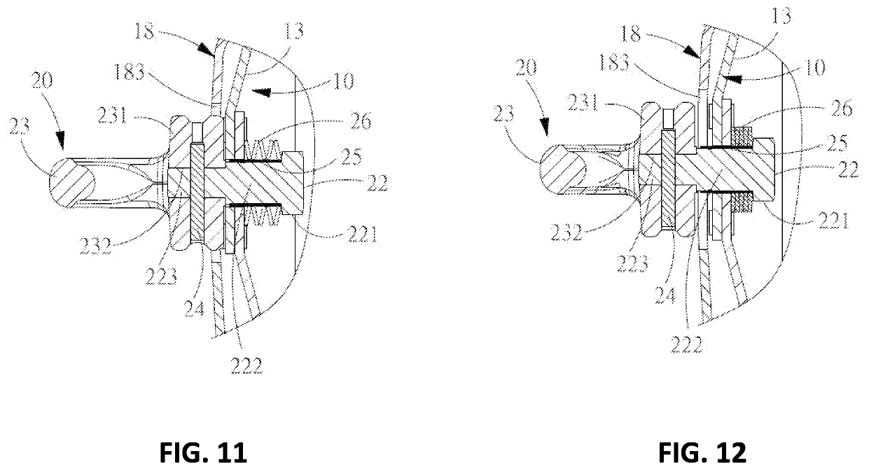

The connection assembly 20, referring to FIGS. 2, 6, 9, 11, and 12, is arranged on the left plate 13 and adapted for connecting with a second buckle B 1, so as for removably coupling the main frame 10 with the second anchoring structure B, wherein the connection assembly 20 has a left hole 21 penetratingly arranged to the left plate 13 to communicate to the chamber 15 and the first hole 183 and for a latch element 22 to pass through and latch. The latch element 22 has a plug portion 221 coaxially provided and kept in the chamber 15, a bolt portion 222 passing through the left hole 21, and a consolidation portion 223 protruding from the first hole 183, wherein the consolidation portion 223 has a retaining ring 23 mounted thereon in the outside of the housing 18 for coupling with the second buckle B1. The retaining ring 23 has a base 231 which has a assembling hole 232 arranged thereon for the consolidation portion 223 to insert into, wherein a pin 24 radially passes through the assembling hole 232 and the consolidation portion 223, so that the latch element 22 and the retaining ring 23 are coupled. An identification ring 25 is provided to be locked on the periphery of the bolt portion 222, wherein a coil spring 26 is sleeved on the periphery of the identification ring 25 in the manner that an end of the coil spring 26 abuts against the plug portion 221, while the other end thereof abuts against the left plate 13, so as to maintain the identification ring 25 concealed within the area of the housing 18, as illustrated in FIG. 11, so as for the user to check if the tension of the cable member 40 is appropriate. When the user utilizes the spanner 17 to drive the central shaft 16 to rotate and increase the tension of the cable member 40 under the horizontal cabling operation while the identification ring 25 passes through the left hole 21, as illustrated in FIG. 12, and approximately aligns to the housing 18, it means that the tension of the cable member 40 has already meet the safety standard, which reminds the user not to continue to rotate the spanner 17. Further, during the horizontal cabling operation, when the tension of the cable member 40 reaches to a certain values, it is able to overcome the coil spring 26, so as to move the identification ring 25 to a corresponding visual observation position, which is within the spirit of the present invention.

The drum 30 is accommodated in the chamber 15 and coaxially affixed on the central shaft 16, referring to FIGS. 2-6. The drum 30 has a first shaft hole 31 on the center thereof for the central shaft 16 to pass through, wherein the first shaft hole 31 has a second key slot 32 for the key block 165 to be mounted therein, so as to allow the central shaft 16 integrally drives the drum 30 to rotate. The drum 30 comprises two end plates 33 respectively mounted on the front side and the rear side thereof, so as to define a round and dented limit space 34 on the periphery of the drum 30.

The cable member 40, preferably 60 feet long, is winded around the limit space 34 of the drum 30, wherein an end of the cable member 40 is affixed at a proper position of the limit space 34, while the other end is adapted for being pulled from the main frame 10 and the second hole 184, so as for mounting the first buckle A1. The middle portion of the cable member 40 is winded around the limit space 34 of the drum 30, so that when the first buckle A1 is buckled on the first anchoring structure A, if the user moves to the direction of the second anchoring structure B, the cable member 40 is capable of pulling the drum 30 and central shaft 16 to rotate, so as to allow the cable member 40 to be gradually pulled out.

The first spring 50 is mounted between the main frame 10 and the central shaft 16, adapted for providing the drum 30 an acting force to constantly retrieve the cable member 40, as illustrated in FIGS. 2-5. The first spring 50 is embodied as turbination spring, wherein the external end of the first spring 50 is mounted on the back side of the rear plate 12 through a fixed seat 51, while the inner end thereof is embedded in the inlay groove 166 of the central shaft 16, so that the first spring 50 is capable of providing an acting force for the drum 30 to retrieve the cable member 40.

The external gear 60 is accommodated in the chamber 15 and coaxially affixed on the central shaft 16 between the end plates on the front sides of the front plate 11 and the drum 30. The external gear 60 has a plurality of gear grooves 61 arranged on the periphery thereof, a second shaft hole 62 on the center thereof for the central shaft 16 to pass through, a brake pad 63 arranged and clamped between the external gear 60 and the drum 30, and a screw cap 64 mounted on the screw segment 163 so that the screw cap 64 locks the external gear 60 through a disc spring 65, such that the brake pad 63 and the drum 30 are clamped and locked between the yoke 162 and the screw cap 64, so as to allow the central shaft 16, the drum 30, and the external gear 60 to integrally rotate without unthreading or looseness.

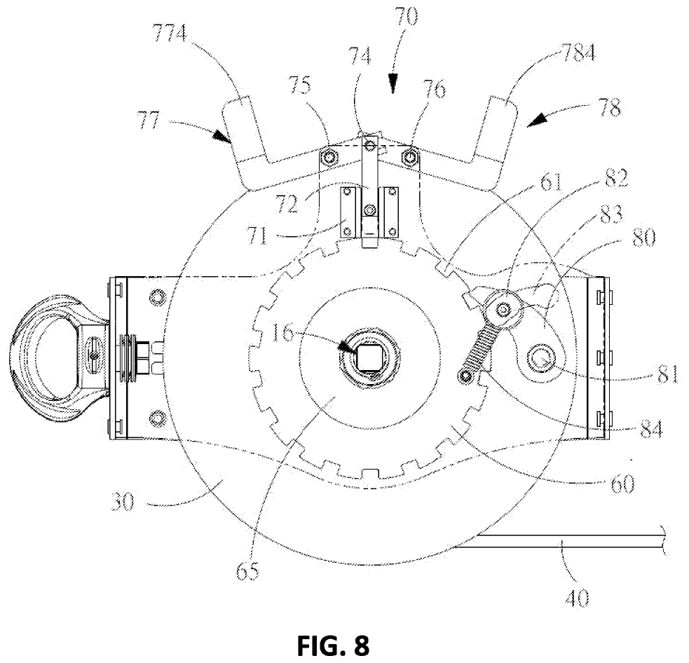

The brake element 70 is mounted on the main frame, referring to FIGS. 2, 3, 4, 5, 7, and 8, having a first state limiting the gear grooves 61 and a second state releasing the gear grooves 61, so that the external gear 60 under the first state is not allowed to rotate forward and backward. The brake element 70 has a slightly arched rail 71 mounted on the back side of the front plate 11, so as to have the front plate 11 and the rail 71 define a perpendicularly penetrating chute 711. The rail 71 leads a buckling member 72 to radially rise and fall along the external gear 60. The buckling member 72 has a first slider 721 slidably arranged in the chute 711, a second slider 722 slidably arranged in the outside of the rail 71, and a block 723 bridging the top end of the first slider 721 and the second slider 722, so that when the block 723 abuts against the top end of the rail 71, the buckling member 72 is at a lower dead point and the second slider 722 is controlled to have the bottom end thereof be embedded in the gear grooves 61 of the external gear 60. Accordingly, the brake element 70 is in the first state limiting the rotation of the external gear 60. In order to keep the first state, the buckling member 72 has a second spring 73 mounted between the buckling member 72 and the front plate 11, wherein the second spring 73 is in the chute 711 between the first slider 721 and the front plate 11. The buckling member 72 also comprises a pin rod 74 mounted on the top of the rail 71. The front plate 11 has a first pivot 75 and a second pivot 76 provided and mounted on the two sides of the pin rod 74 in an equal distance, so as correspondingly for a first trigger 77 and a second trigger 78 to be coupled therewith. The first trigger 77 has a first arm 771 adjacent to the back side of the front plate 11, a first groove 772 arranged on an end of the first arm 771 to be coupled with the pin rod 74, and a second arm 773 arranged on the other end thereof and extended to the direction of the drum 30, so as to couple a first pivot 75 between the two ends of the first arm 771 and to control the distance between the first pivot 75 and the pin rod 74 to be shorter than the distance between the first pivot 75 and the second arm 773, so as to construct a labor leverage. The second arm 773 has a third arm 774 extended upwardly from the free end. The second trigger 78 has a fourth arm 781 adjacent to the back side of the front plate 11, wherein the fourth arm 781 has a second groove 782 arranged on an end thereof coupling with the pin rod 74 and a fifth arm 783 extended from the other end thereof toward the direction of the drum 30, so as to have the second pivot 76 coupled between the two ends of the fourth arm 781 and further have the distance between the second pivot 76 and the pin rod 74 shorter than the distance between the second pivot 76 and the fifth arm 783. The fifth arm 783 has a sixth arm 784 upwardly extended from the free end thereof. The user can easily overcome the second spring 73 through operating either the third arm 774 or the sixth arm 784, so as to have the bottom end of the second slider 722 leaving the corresponding gear grooves 61 to switch to the second state that releases the external gear 60. In order for reducing labor, the housing 18 has a handle 185 arranged thereon covering and embracing the third arm 774 and the sixth arm 784, wherein the handle 185 not only facilitates the carrying of the handle, but allow the user's finger to turn the first trigger 77 and the second trigger 78.

The detent 80, which is mounted on the main frame 10, has a first position to mesh with the gear grooves 61 and a second position to free the gear grooves 61 in order to only allow the external gear 60 to rotate unidirectionally when the detent 80 is in the first position, so as to control the detent 80 at the first position to stop the drum 30 from retrieving the cable member 40 and only to allow the cable member 40 to be gradually pulled out when the first spring 50 is overcome. An end of the detent 80 is pivotally connected on the back side of the front plate 11 through a support shaft 81, while the other end of the detent 80 has a control handle 82 mounted thereon. The front plate 11 has a first guide slot 83 arranged thereon for guiding the control handle 82, so as to allow the control handle 82 to drive the detent 80 to swing based on the support shaft 81 as a center, so as to be switched and positioned between the first position and the second position. The housing 18 has a second guide slot 186 arranged thereon matching with the first guide slot 83, wherein the second guide slot 186 is adapted for the control handle 82 to pass through, so that the front end of the control handle 82 can be exposed from the housing 18, which therefore allows the user to control the detent 80 to switch between the first position and the second position. When the detent 80 has a third spring 84 mounted between the detent 80 and the front plate 11 in order to constantly keep the detent 80 at the first position while the control handle 82 is utilized to drive and position the detent 80 to the second position, it has to overcome the restoring force exerted by the third spring 84 to do so.

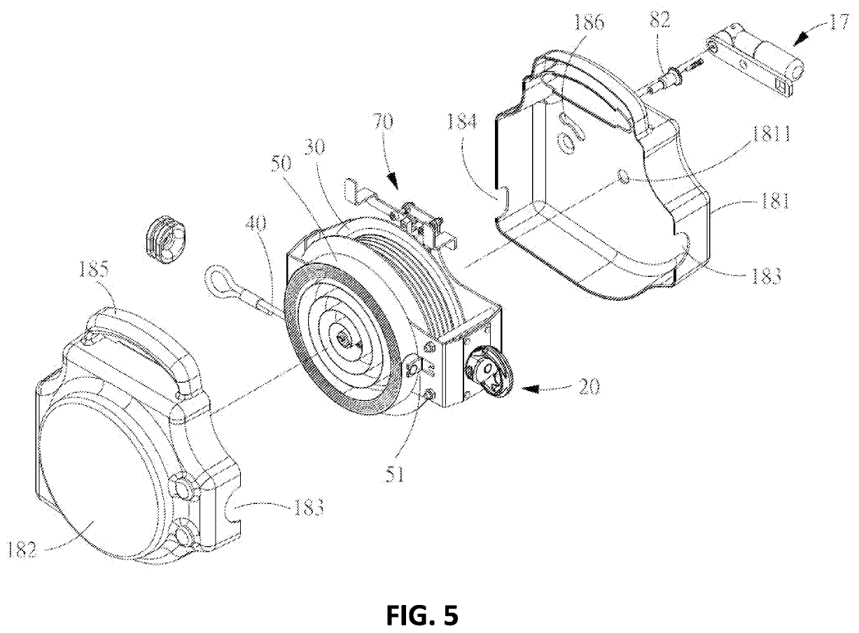

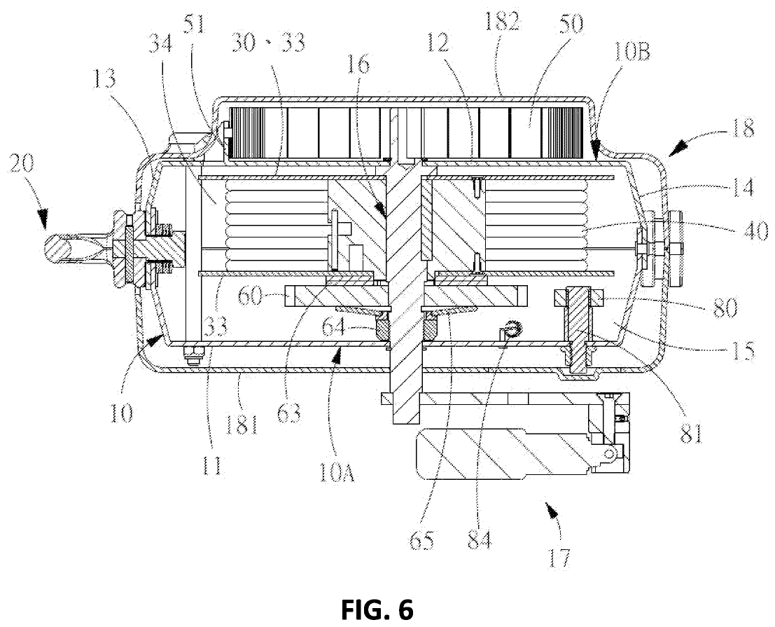

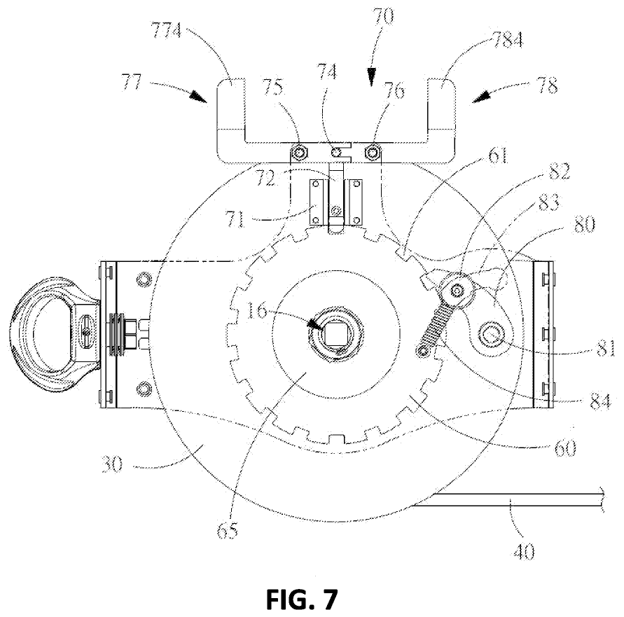

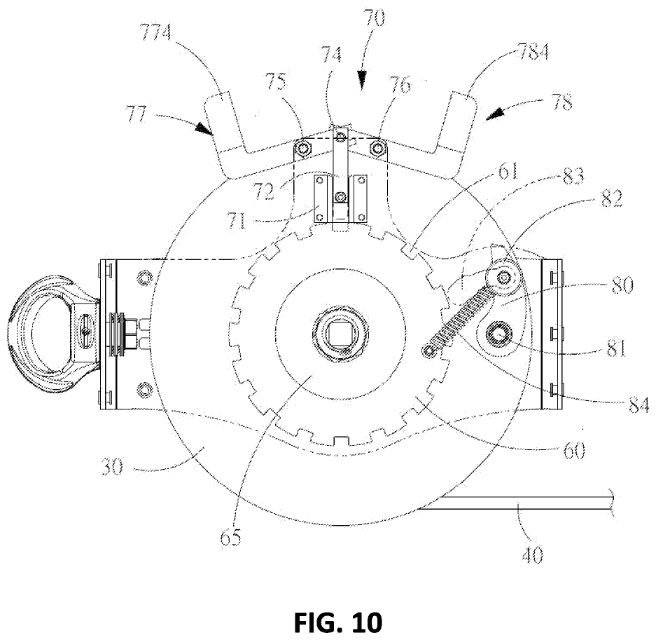

When the temporary horizontal lifeline device of the present invention is utilized for conducting a horizontal cabling operation, referring to FIG. 9, the first buckle A1 has first to be buckled with the first anchoring structure A for affixing the other end of the cable member 40. Referring to FIG. 9, the brake element 70 is operated to be under the second state, and the detent 80 is still be kept at the first position at this moment, so when the user carries the housing 18 to move to the direction of the second anchoring structure B, the cable member 40 will be brought to overcome the first spring 50, as illustrated in FIGS. 5 and 6, so as to drive the drum 30 to rotate and to gradually pull out the cable member 40 until the connection assembly 20 is allowed to utilized the second buckle B1 to buckle the second anchoring structure B. Then, referring to FIG. 10, when the brake element 70 is operated to be under the second state and it overcomes the third spring 84 from forcing the detent 80 to the second position, it leads the detent 80 to release the external gear 60, so that the user may utilize the spanner 17 to drive the central shaft 16 to rotate so as to increase the tension of the cable member 40 in the horizontal cabling operation. Referring to FIG. 12, when the identification ring 25 is about aligned with the housing 18, the tension adjustment is finished. Finally, referring to FIG. 7, the brake element 70 is released to return to the first state and the detent 80 is adjusted to return to the first position, so that the brake element 70 and the detent provide double security to the horizontal cabling. When the user finishes the user's job and is ready for conducting the retrieving operation, the user only has to operate the brake element 70 to the second state, as illustrated in FIG. 10, and forcefully adjust the detent 80 to the second position to enable the first spring 50 to effectively drive the drum 30 to retrieve the cable member 40. Preferably, the user only has to carry the housing 18 with one hand and move to the first anchoring structure A to easily retrieve the cable member 40. After the retrieving process is completed, the user may, as illustrated in FIG. 7, release the brake element 70 to have it return to the first state and adjust the detent 80 to return to the first position and then decouples the first buckle A1 from the first anchoring structure A to complete the entire practice.

Accordingly, the temporary horizontal lifeline device of the present invention at least provides the following advantages:

First, for the user performing cable retrieving operation, the temporary horizontal lifeline device of the present invention only needs to have the brake element under the second state and the detent at the second position to eliminate the damping action of the prior art. Then, the first spring may smoothly drives the drum to retrieve the cable member, which is not only labor saving, but also easy for cable retrieving with one hand, providing relatively easy overall operation and greatly enhancing the security of the personnel moving and cable retrieving.

Second, after the cabling operation, the temporary horizontal lifeline device of the present invention can have the brake element be switched to the first state and the detent be switched to the first position, so that the cable responding to personnel falling mainly with the brake element to lock the external gear from rotating forward and backward besides of with the detent. Accordingly, the present invention is capable of enhancing the stress concentration issues of the prior art.

Third, the brake element, according to the preferred embodiment of the present invention, utilizes a rail to guide a buckling member, leading the buckling member to move along the external gear to radially engage with the gear grooves of the external gear, so as to allow the brake element being in the first state to restrict the external gear from rotating. This arrangement that directly brakes the external gear actually provides an advantage in enhancing the arm of resistance force in contrasting to the prior technologies. Besides, the stability for the rail and the buckling member braking the external gear is better as well.

What is claimed is:

1. A temporary horizontal lifeline device, comprising:
a main frame comprising a central shaft pivotally arranged thereon and a spanner mounted thereon, adapted for driving said central shaft to rotate;
a drum coaxially affixed on said central shaft;
a cable member winded around said drum, wherein an end of said cable member is affixed on said drum, while another end thereof is free to be pulled from said main frame;
a first spring mounted on said main frame so as to provide said drum a constant force for retrieving said cable member;
an external gear, coaxially affixed on said central shaft, having a plurality of gear grooves arranged on the periphery thereof;
a brake element, mounted on said main frame, having a first state to limit said gear grooves and a second state to free said gear grooves, so as to hold said external gear from rotate forward and backward when said brake element is in the first state; and
a detent, mounted on said main frame, having a first position meshed with said gear grooves and a second position to free said gear grooves so as to only allow said external gear to rotate unidirectionally when said detent is in the first position.

2. The temporary horizontal lifeline device, as recited in claim 1, wherein said brake element comprises a rail, a buckling member, and a second spring, wherein said rail is affixed on said main frame and adapted for guiding said buckling member to radially move along said external gear, such that said buckling member is adapted to mesh with said gear grooves in the first state and disengaged from said gear grooves in the second state, wherein said second spring is arranged between said buckling member and said main frame so as to keep said buckling member to constantly maintain the first state.

3. The temporary horizontal lifeline device, as recited in claim 2, wherein said brake element further comprises a pin rod mounted on said buckling member, a first pivot and a second pivot respectively mounted on two sides of said pin rod, a first trigger coupled with said pin rod and said first pivot, and a second trigger coupled with said pin rod and said second pivot, such that said first trigger and said second trigger are allowed to be utilized to overcome said second spring for switching to the second state.

4. The temporary horizontal lifeline device, as recited in claim 3, wherein said first trigger has a first arm which has a first groove arranged on one end thereof coupled with said pin rod and a second arm extended from the other end thereof, wherein said first pivot is coupled with said first arm between the two ends thereof to control the distance between said first pivot and said pin rod shorter than the distance between said first pivot and said second arm, wherein said second arm has a third arm extended from the free end thereof, wherein said second trigger has a fourth arm which has a second groove on an end thereof coupled with said pin rod and a fifth arm extended from the other end thereof, wherein said second pivot is coupled with said fourth arm between the two ends thereof and the distance between said second pivot and said pin rod is controlled to be shorter than the distance between said second pivot and said fifth arm, wherein said fifth arm has a sixth arm extended from the free end thereof, such that both said third arm and said sixth arm is adapted to be operated to overcome said second spring for switching to the second state, wherein said main frame further comprises a housing covered on the periphery thereof, wherein said housing has a handle arranged thereon covering and embracing said third arm and said sixth arm.

5. The temporary horizontal lifeline device, as recited in claim 2, wherein said rail has a chute perpendicularly penetrating between said rail and said main frame, wherein said buckling member has a first slider slidably arranged in said chute, a second slider slidably arranged in the outside of said rail, and a block bridging said first slider and said second slider so that when said block abut the top end of said rail, said buckling member is at a lower dead point and said second slider is controlled to be embedded in said gear grooves of said external gear, so that said brake element in the first state limiting the rotation of said external gear.

6. The temporary horizontal lifeline device, as recited in claim 4, wherein said rail has a chute perpendicularly penetrating between said rail and said main frame, wherein said buckling member has a first slider slidably arranged in said chute, a second slider slidably arranged in the outside of said rail, and a block bridging said first slider and said second slider so that when said block abut the top end of said rail, said buckling member is at a lower dead point and said second slider is controlled to be embedded in said gear grooves of said external gear, so that said brake element in the first state limiting the rotation of said external gear.

7. The temporary horizontal lifeline device, as recited in claim 1, wherein when said brake element is in the second state and said detent is at the first position, said detent stops said drum to retrieve said cable member and only allows said cable member to be gradually pulled from said drum, wherein when said brake element is in the second state and said detent is at the second position, said first spring is allowed to bring said drum to retrieve said cable member.

8. The temporary horizontal lifeline device, as recited in claim 4, wherein when said brake element is in the second state and said detent is at the first position, said detent stops said drum to retrieve said cable member and only allows said cable member to be gradually pulled from said drum, wherein when said brake element is in the second state and said detent is at the second position, said first spring is allowed to bring said drum to retrieve said cable member.

9. The temporary horizontal lifeline device, as recited in claim 6, wherein when said brake element is in the second state and said detent is at the first position, said detent stops said drum to retrieve said cable member and only allows said cable member to be gradually pulled from said drum, wherein when said brake element is in the second state and said detent is at the second position, said first spring is allowed to bring said drum to retrieve said cable member.

10. The temporary horizontal lifeline device, as recited in claim 1, wherein said detent has a support shaft pivotally mounted on said main frame and a control handle mounted thereon, wherein said main frame has a first guide slot adapted for guiding said control handle, so as to allow the switching and positioning between the first position and the second position when said control handle drive said detent to swing based on said support shaft as a center, wherein said detent further has a third spring arranged between said detent and said main frame adapted for keeping said detent at the first position, wherein said main frame comprises a housing covered on the periphery thereof, wherein said housing has a second guide slot arranged thereon for said control handle to pass through.

11. The temporary horizontal lifeline device, as recited in claim 4, wherein said detent has a support shaft pivotally mounted on said main frame and a control handle mounted thereon, wherein said main frame has a first guide slot adapted for guiding said control handle, so as to allow the switching and positioning between the first position and the second position when said control handle drive said detent to swing based on said support shaft as a center, wherein said detent further has a third spring arranged between said detent and said main frame adapted for keeping said detent at the first position, wherein said main frame comprises a housing covered on the periphery thereof, wherein said housing has a second guide slot arranged thereon for said control handle to pass through.

12. The temporary horizontal lifeline device, as recited in claim 9, wherein said detent has a support shaft pivotally mounted on said main frame and a control handle mounted thereon, wherein said main frame has a first guide slot adapted for guiding said control handle, so as to allow the switching and positioning between the first position and the second position when said control handle drive said detent to swing based on said support shaft as a center, wherein said detent further has a third spring arranged between said detent and said main frame adapted for keeping said detent at the first position, wherein said main frame comprises a housing covered on the periphery thereof, wherein said housing has a second guide slot arranged thereon for said control handle to pass through.

13. The temporary horizontal lifeline device, as recited in claim 1, wherein said main frame further has a front plate, a rear plate, and a left plate so as to define a chamber thereamong for accommodating and mounting said drum and said external gear, wherein a housing is covered on said main frame, wherein said housing has a first hole penetratingly arranged on the left end thereof and a second hole penetratingly arranged on the right end thereof for said cable member to pass in and out, wherein said left plate has a connection assembly mounted thereon, wherein said connection assembly has a left hole penetratingly arranged to said left plate for communicating said chamber and said first hole, so as for a latch element to pass through and latch, wherein said latch element has a plug portion maintaining in said chamber, a bolt portion penetrating said left hole, and a consolidation portion protruding from said first hole, wherein said consolidation portion is coupled with a retaining ring in the outside of said housing, wherein said bolt portion comprises an identification ring mounted on the periphery thereof, wherein said identification ring comprises a coil spring sleeved on the periphery thereof, wherein an end of said coil spring abuts against said plug portion, while another end thereof abuts against said left plate, so that during a horizontal cabling operation when a tension of said cable member reaches a predetermined value, a force of said coil spring is overcome, rendering said identification ring to move to a corresponding visual observation position.

14. The temporary horizontal lifeline device, as recited in claim 4, wherein said main frame further has a front plate, a rear plate, and a left plate so as to define a chamber thereamong for accommodating and mounting said drum and said external gear, wherein a housing is covered on said main frame, wherein said housing has a first hole penetratingly arranged on the left end thereof and a second hole penetratingly arranged on the right end thereof for said cable member to pass in and out, wherein said left plate has a connection assembly mounted thereon, wherein said connection assembly has a left hole penetratingly arranged to said left plate for communicating said chamber and said first hole, so as for a latch element to pass through and latch, wherein said latch element has a plug portion maintaining in said chamber, a bolt portion penetrating said left hole, and a consolidation portion protruding from said first hole, wherein said consolidation portion is coupled with a retaining ring in the outside of said housing, wherein said bolt portion comprises an identification ring mounted on the periphery thereof, wherein said identification ring comprises a coil spring sleeved on the periphery thereof, wherein an end of said coil spring abuts against said plug portion, while another end thereof abuts against said left plate, so that during a horizontal cabling operation when a tension of said cable member reaches a predetermined value, a force of said coil spring is overcome, rendering said identification ring to move to a corresponding visual observation position.

15. The temporary horizontal lifeline device, as recited in claim 12, wherein said main frame further has a front plate, a rear plate, and a left plate so as to define a chamber thereamong for accommodating and mounting said drum and said external gear, wherein a housing is covered on said main frame, wherein said housing has a first hole penetratingly arranged on the left end thereof and a second hole penetratingly arranged on the right end thereof for said cable member to pass in and out, wherein said left plate has a connection assembly mounted thereon, wherein said connection assembly has a left hole penetratingly arranged to said left plate for communicating said chamber and said first hole, so as for a latch element to pass through and latch, wherein said latch element has a plug portion maintaining in said chamber, a bolt portion penetrating said left hole, and a consolidation portion protruding from said first hole, wherein said consolidation portion is coupled with a retaining ring in the outside of said housing, wherein said bolt portion comprises an identification ring mounted on the periphery thereof, wherein said identification ring comprises a coil spring sleeved on the periphery thereof, wherein an end of said coil spring abuts against said plug portion, while another end thereof abuts against said left plate, so that during a horizontal cabling operation when a tension of said cable member reaches a predetermined value, a force of said coil spring is overcome, rendering said identification ring to move to a corresponding visual observation position.

16. The temporary horizontal lifeline device, as recited in claim 1, wherein said main frame further has a front plate and a rear plate to define a chamber therebetween for accommodating and mounting said drum and said external gear, wherein said central shaft has a yoke, a screw segment, and a first key slot arranged in said chamber, wherein said first key slot comprises a key block mounted therein, wherein said drum has a first shaft hole provided thereon for said central shaft to pass through, wherein said first shaft hole has a second key slot arranged thereon for said key block to be mounted therein, a second shaft hole is arranged on said external gear for said central shaft to pass through, a brake pad provided between said external gear and said drum, a screw cap mounted on said screw segment, and a disc spring locked by said screw cap on said external gear, so as to lock said external gear, said brake pad, and said drum between said yoke and said screw cap.

17. The temporary horizontal lifeline device, as recited in claim 4, wherein said main frame further has a front plate and a rear plate to define a chamber therebetween for accommodating and mounting said drum and said external gear, wherein said central shaft has a yoke, a screw segment, and a first key slot arranged in said chamber, wherein said first key slot comprises a key block mounted therein, wherein said drum has a first shaft hole provided thereon for said central shaft to pass through, wherein said first shaft hole has a second key slot arranged thereon for said key block to be mounted therein, a second shaft hole is arranged on said external gear for said central shaft to pass through, a brake pad provided between said external gear and said drum, a screw cap mounted on said screw segment, and a disc spring locked by said screw cap on said external gear, so as to lock said external gear, said brake pad, and said drum between said yoke and said screw cap.

18. The temporary horizontal lifeline device, as recited in claim 15, wherein said main frame further has a front plate and a rear plate to define a chamber therebetween for accommodating and mounting said drum and said external gear, wherein said central shaft has a yoke, a screw segment, and a first key slot arranged in said chamber, wherein said first key slot comprises a key block mounted therein, wherein said drum has a first shaft hole provided thereon for said central shaft to pass through, wherein said first shaft hole has a second key slot arranged thereon for said key block to be mounted therein, a second shaft hole is arranged on said external gear for said central shaft to pass through, a brake pad provided between said external gear and said drum, a screw cap mounted on said screw segment, and a disc spring locked by said screw cap on said external gear, so as to lock said external gear, said brake pad, and said drum between said yoke and said screw cap.

19. The temporary horizontal lifeline device, as recited in claim 1, wherein said main frame further has a front plate and a rear plate to define a chamber therebetween for accommodating and mounting said drum and said external gear, wherein a front end of said central shaft protrudes from a front side of said front plate, wherein said central shaft has a lever portion arranged on the front end thereof, wherein said main frame comprises a housing covered on the periphery thereof, wherein said housing has an aperture provided thereon for said lever portion to pass through, wherein a rear end of said central shaft protrudes from a rear side of said rear plate, wherein said central shaft further has an inlay groove radially provided on the rear end thereof, wherein said first spring is a turbination spring with an external end thereof mounted on a rear side of said rear plate through said fixed seat, while an inner end of said first spring is embedded in said inlay groove.

20. The temporary horizontal lifeline device, as recited in claim 4, wherein said main frame further has a front plate and a rear plate to define a chamber therebetween for accommodating and mounting said drum and said external gear, wherein a front end of said central shaft protrudes from a front side of said front plate, wherein said central shaft has a lever portion arranged on the front end thereof, wherein said main frame comprises a housing covered on the periphery thereof, wherein said housing has an aperture provided thereon for said lever portion to pass through, wherein a rear end of said central shaft protrudes from a rear side of said rear plate, wherein said central shaft further has an inlay groove radially provided on the rear end thereof, wherein said first spring is a turbination spring with an external end thereof mounted on a rear side of said rear plate through said fixed seat, while an inner end of said first spring is embedded in said inlay groove.
